(19) United States
(12) Patent Application Publication
(10) Pub. No.: US 2026/0322419 A1
(43) Pub. Date: Oct. 15, 2026

(54) HIGH-FREQUENCY SIGNAL TRANSMISSION/RECEPTION CIRCUIT

(71) Applicant: Murata Manufacturing Co., Ltd., Nagaokakyo-shi (JP)

(72) Inventor: Takeshi OSHIMA, Nagaokakyo-shi (JP)

(21) Appl. No.: 19/636,262

(22) Filed: Apr. 1, 2026

(30) Foreign Application Priority Data
Apr. 14, 2025 (JP) 2025-066374

(51) Int. Cl. H04B 1/44; H04L 5/00

(52) U.S. Cl. CPC H04B 1/44; H04L 5/0051

(57) ABSTRACT

A high-frequency signal transmission/reception circuit is a high-frequency signal transmission/reception circuit that transmits an SRS signal, including: a transmission/reception antenna terminal; a TRX switch that switches between a path from an amplifier that amplifies a transmission signal to the transmission/reception antenna terminal and a path to a changeover switch; a reception antenna; and a reception circuit. The reception circuit includes a reception antenna terminal, an amplifying unit that amplifies a reception signal, and a bypass switch. The changeover switch is connected between the TRX switch and the reception circuit. By the changeover switch, the SRS signal inputted via the bypass switch is transmitted via the reception antenna terminal.

### CROSS REFERENCE TO RELATED APPLICATION

This application claims priority from Japanese Patent Application No. 2025-066374, filed on April 14, 2025. The content of this application is incorporated herein by reference in its entirety.

### BACKGROUND OF THE DISCLOSURE

### 1. Field of the Disclosure

The present disclosure relates to a high-frequency signal transmission/reception circuit.

### 2. Description of the Related Art

SRS (Sound Reference Signaling) is performed in mobile communication devices exemplified by mobile phone devices. In SRS, an SRS signal is transmitted from the mobile communication device, and the power and delay of a transmission path between each antenna port in the mobile communication device and the base station is monitored. The SRS signal is a signal that conveys transmission information from the mobile communication device to the base station.

A mobile communication device including a high-frequency signal transmission/reception circuit for transmitting an SRS signal is disclosed in Japanese Unexamined Patent Application Publication No. 2020-182205. The high-frequency signal transmission/reception circuit disclosed in Japanese Unexamined Patent Application Publication No. 2020-182205 has a low-noise amplifier that amplifies a signal received by a reception antenna. In the case of transmitting an SRS signal, the low-noise amplifier is bypassed by setting a changeover switch, and an SRS signal is transmitted using the reception antenna.

In the mobile communication device disclosed in Japanese Unexamined Patent Application Publication No. 2020-182205 mentioned above, it is necessary to provide the changeover switch for bypassing the low-noise amplifier, which may result in an increase in circuit scale.

### BRIEF SUMMARY OF THE DISCLOSURE

Accordingly, it is a possible benefit of the present disclosure to provide a high-frequency signal transmission/reception circuit capable of transmitting an SRS signal using a reception antenna without involving an increase in circuit scale.

In order to solve the above-mentioned issue and to achieve the possible benefit, a high-frequency signal transmission/reception circuit according to one aspect of the present disclosure is a high-frequency signal transmission/reception circuit that transmits an SRS signal, including: a transmission/reception antenna terminal; a TRX switch that switches between a path from an amplifier that amplifies a transmission signal to the transmission/reception antenna terminal and a path to a changeover switch; a reception antenna; and a reception circuit. The reception circuit includes a reception antenna terminal, an amplifying unit that amplifies a reception signal, and a bypass switch. The changeover switch is connected between the TRX switch and the reception circuit. By the changeover switch, the SRS signal inputted via the bypass switch is transmitted via the reception antenna terminal.

According to the present disclosure, it is possible to suppress an increase in circuit scale by inputting an SRS signal between the reception antenna and the amplifying unit.

### BRIEF DESCRIPTION OF THE SEVERAL VIEWS OF THE DRAWINGS

FIG. 1 is a diagram illustrating the configuration of a high-frequency signal transmission/reception circuit of a comparative example;

FIG. 2 is a diagram illustrating the operation of the high-frequency signal transmission/reception circuit of the comparative example;

FIG. 3 is a diagram illustrating the configuration of a high-frequency signal transmission/reception circuit of a first embodiment;

FIG. 4 is a diagram illustrating the operation of the high-frequency signal transmission/reception circuit of the first embodiment;

FIG. 5 is a diagram illustrating an example of a transmission path for an SRS signal;

FIG. 6 is a diagram illustrating the configuration of a high-frequency signal transmission/reception circuit of a second embodiment;

FIG. 7 is a diagram illustrating the configuration of a high-frequency signal transmission/reception circuit of a third embodiment;

FIG. 8 is a diagram illustrating the operation of the high-frequency signal transmission/reception circuit of the third embodiment; and

FIG. 9 is a diagram illustrating the configuration of a high-frequency signal transmission/reception circuit of a fourth embodiment.

### DETAILED DESCRIPTION OF THE DISCLOSURE

Hereinafter, embodiments of the present disclosure will be described in detail on the basis of the drawings. In the following description of the embodiments, elements that are identical or equivalent to those of other embodiments are denoted by the same reference numerals, and description thereof will be simplified or omitted. The present disclosure is not limited by these embodiments. Additionally, elements of each embodiment include those that are substitutable by a person skilled in the art in an interchangeable and readily conceivable manner, or those that are substantially the same. Note that the configurations described below can be combined as appropriate. Moreover, omission, substitution, or modification of configurations may be made without departing from the gist of the disclosure.

### First Embodiment

Hereinafter, a first embodiment will be described. In order to facilitate understanding of the first embodiment, a comparative example will be described first.

### Comparative Example

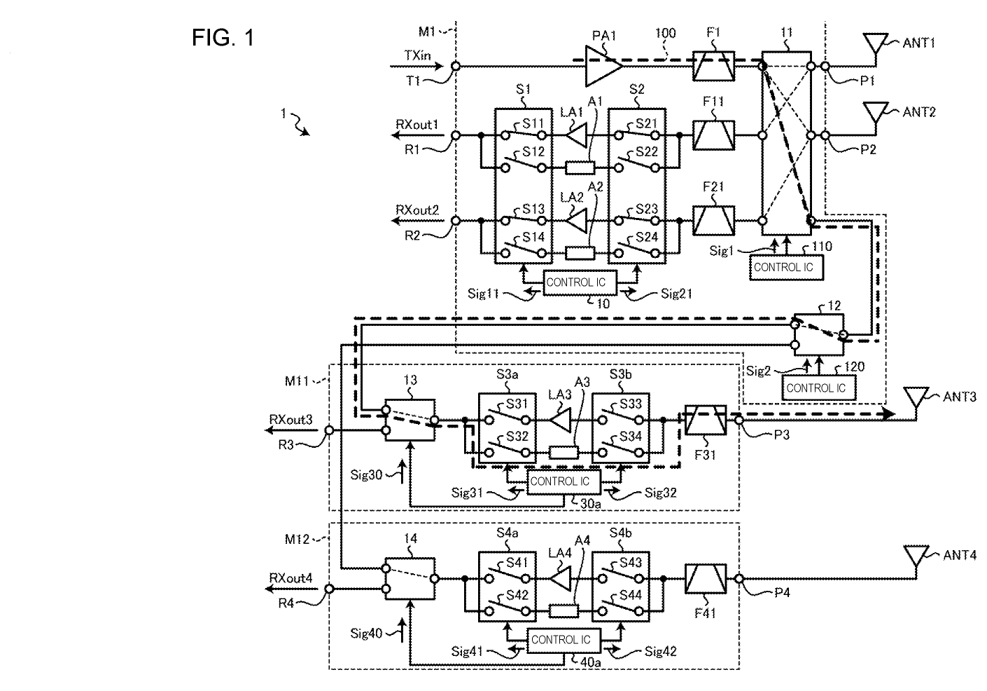

FIG. 1 is a diagram illustrating the configuration of a high-frequency signal transmission/reception circuit 1 of the comparative example. The high-frequency signal transmission/reception circuit 1 of the comparative example includes modules M1, M11, and M12. The module M1 is electrically connected to antennas ANT1 and ANT2. The module M11 is electrically connected to an antenna ANT3. The module M12 is electrically connected to an antenna ANT4.

The high-frequency signal transmission/reception circuit 1 supports 2T4R in which, in the case of normal communication, radio waves are transmitted from the antennas ANT1 and ANT2, and radio waves are received by the antennas ANT1, ANT2, ANT3, and ANT4. In the present disclosure, normal communication refers to communication of user data, audio, and the like, and it excludes SRS (Sound Reference Signaling). Hereinafter, signals to be transmitted other than SRS signals are referred to as normal transmission signals. The high-frequency signal transmission/reception circuit 1 transmits SRS signals when normal transmission signals are not being transmitted.

During SRS communication, the high-frequency signal transmission/reception circuit 1 transmits radio waves from the antenna ANT3 or ANT4. Normally, the antennas ANT3 and ANT4 are reception-only antennas, but in SRS, transmission signals outputted from a power amplifier PA1 are transmitted via the antennas ANT3 and ANT4 in order to check the communication state and loss of these antennas and the base station.

The module M1 includes terminals R1, R2, T1, P1, and P2, the power amplifier PA1, low-noise amplifiers LA1 and LA2, attenuators A1 and A2, switch groups S1 and S2, band-pass filters F1, F11, and F21, a transmission/reception (TRX) switch 11, a switch 12, and control ICs 10, 110, and 120. The switch group S1 includes switches S11, S12, S13, and S14. The switch group S2 includes switches S21, S22, S23, and S24.

An input terminal of the power amplifier PA1 is electrically connected to the terminal T1. An output terminal of the power amplifier PA1 is electrically connected to a first end of the band-pass filter F1. A second end of the band-pass filter F1 is connected to the TRX switch 11.

The terminal R1 is electrically connected to a first end of the switch S11 and a first end of the switch S12. A second end of the switch S11 is electrically connected to an output terminal of the low-noise amplifier LA1. An input terminal of the low-noise amplifier LA1 is electrically connected to a first end of the switch S21. A second end of the switch S12 is electrically connected to a first end of the attenuator A1. A second end of the attenuator A1 is electrically connected to a first end of the switch S22. A second end of the switch S21 and a second end of the switch S22 are electrically connected to a first end of the band-pass filter F11. A second end of the band-pass filter F11 is connected to the TRX switch 11.

The terminal R2 is electrically connected to a first end of the switch S13 and a first end of the switch S14. A second end of the switch S13 is electrically connected to an output terminal of the low-noise amplifier LA2. An input terminal of the low-noise amplifier LA2 is electrically connected to a first end of the switch S23. A second end of the switch S14 is electrically connected to a first end of the attenuator A2. A second end of the attenuator A2 is electrically connected to a first end of the switch S24. A second end of the switch S23 and a second end of the switch S24 are electrically connected to a first end of the band-pass filter F21. A second end of the band-pass filter F21 is connected to the TRX switch 11.

The passband of the band-pass filter F21 is the same as the passband of the band-pass filter F11; however, the present disclosure is not limited thereto.

Each switch in the switch group S1 enters an on state or an off state based on a control signal Sig11 inputted from the control IC 10. Each switch in the switch group S2 enters an on state or an off state based on a control signal Sig21 inputted from the control IC 10.

The antenna ANT1 is connected to the TRX switch 11 with the terminal P1 interposed therebetween, and the antenna ANT2 is connected to the TRX switch 11 with the terminal P2 interposed therebetween. Additionally, the first end of the switch 12 is connected to the TRX switch 11. The TRX switch 11 is a switch that electrically connects the antennas ANT1 and ANT2 and the switch 12 with the band-pass filters F1, F11, and F21 during transmission and reception operations. Based on a control signal Sig1 inputted from the control IC 110, the TRX switch 11 electrically connects the antennas ANT1 and ANT2 with the band-pass filters F1, F11, and F21. The TRX switch 11 corresponds to the TRX switch 11 of the present disclosure.

The modules M11 and M12 are connected to the second end of the switch 12. Based on a control signal Sig2 inputted from the control IC 120, the switch 12 connects its second end to the module M11 or the M12.

The module M11 includes terminals R3 and P3, a switch 13, a switch group S3a, a low-noise amplifier LA3, an attenuator A3, a switch group S3b, a band-pass filter F31, and a control IC 30a. The switch group S3a includes switches S31 and S32. The switch group S3b includes switches S33 and S34. The low-noise amplifier LA3 corresponds to an amplifying unit of the present disclosure. The switch S31 corresponds to an output-side switch of the present disclosure. The switch S33 corresponds to an input-side switch of the present disclosure. In the module M11, the band-pass filter F31 is provided between the low-noise amplifier LA3 and the terminal P3.

The terminal R3 is electrically connected to one of the terminals of the switch 13. The switch 12 of the module M1 is connected to another terminal of the switch 13.

A first end of the switch S31 and a first end of the switch S32 are connected to the switch 13. A second end of the switch S31 is electrically connected to an output terminal of the low-noise amplifier LA3. An input terminal of the low-noise amplifier LA3 is electrically connected to a first end of the switch S33. A second end of the switch S32 is electrically connected to a first end of the attenuator A3. A second end of the attenuator A3 is electrically connected to a first end of the switch S34. A second end of the switch S33 and a second end of the switch S34 are electrically connected to a first end of the band-pass filter F31. A second end of the band-pass filter F31 is electrically connected to the antenna ANT3 with the terminal P3 interposed therebetween. The terminal P3 corresponds to a reception antenna terminal of the present disclosure.

Based on a control signal Sig30 inputted from the control IC 30a, the switch 13 connects to the module M11 or the terminal R3. Each switch in the switch group S3a enters an on state or an off state based on a control signal Sig31 inputted from the control IC 30a. Each switch in the switch group S3b enters an on state or an off state based on a control signal Sig32 inputted from the control IC 30a.

The module M12 includes terminals R4 and P4, a switch 14, a switch group S4a, a low-noise amplifier LA4, an attenuator A4, a switch group S4b, a band-pass filter F41, and a control IC 40a. The switch group S4a includes switches S41 and S42. The switch group S4b includes switches S43 and S44. The low-noise amplifier LA4 corresponds to the amplifying unit of the present disclosure. The switch S41 corresponds to the output-side switch of the present disclosure. The switch S43 corresponds to the input-side switch of the present disclosure. In the module M12, the band-pass filter F41 is provided between the low-noise amplifier LA4 and the terminal P4.

The terminal R4 is electrically connected to one of the terminals of the switch 14. The switch 12 of the module M1 is connected to another terminal of the switch 14.

A first end of the switch S41 and a first end of the switch S42 are connected to the switch 14. A second end of the switch S41 is electrically connected to an output terminal of the low-noise amplifier LA4. An input terminal of the low-noise amplifier LA4 is electrically connected to a first end of the switch S43. A second end of the switch S42 is electrically connected to a first end of the attenuator A4. A second end of the attenuator A4 is electrically connected to a first end of the switch S44. A second end of the switch S43 and a second end of the switch S44 are electrically connected to a first end of the band-pass filter F41. A second end of the band-pass filter F41 is electrically connected to the antenna ANT4 with the terminal P4 interposed therebetween. The terminal P4 corresponds to the reception antenna terminal of the present disclosure.

Based on a control signal Sig40 inputted from the control IC 40a, the switch 14 connects to the module M11 or the terminal R4. Each switch in the switch group S4a enters an on state or an off state based on a control signal Sig41 inputted from the control IC 40a. Each switch in the switch group S4b enters an on state or an off state based on a control signal Sig42 inputted from the control IC 40a.

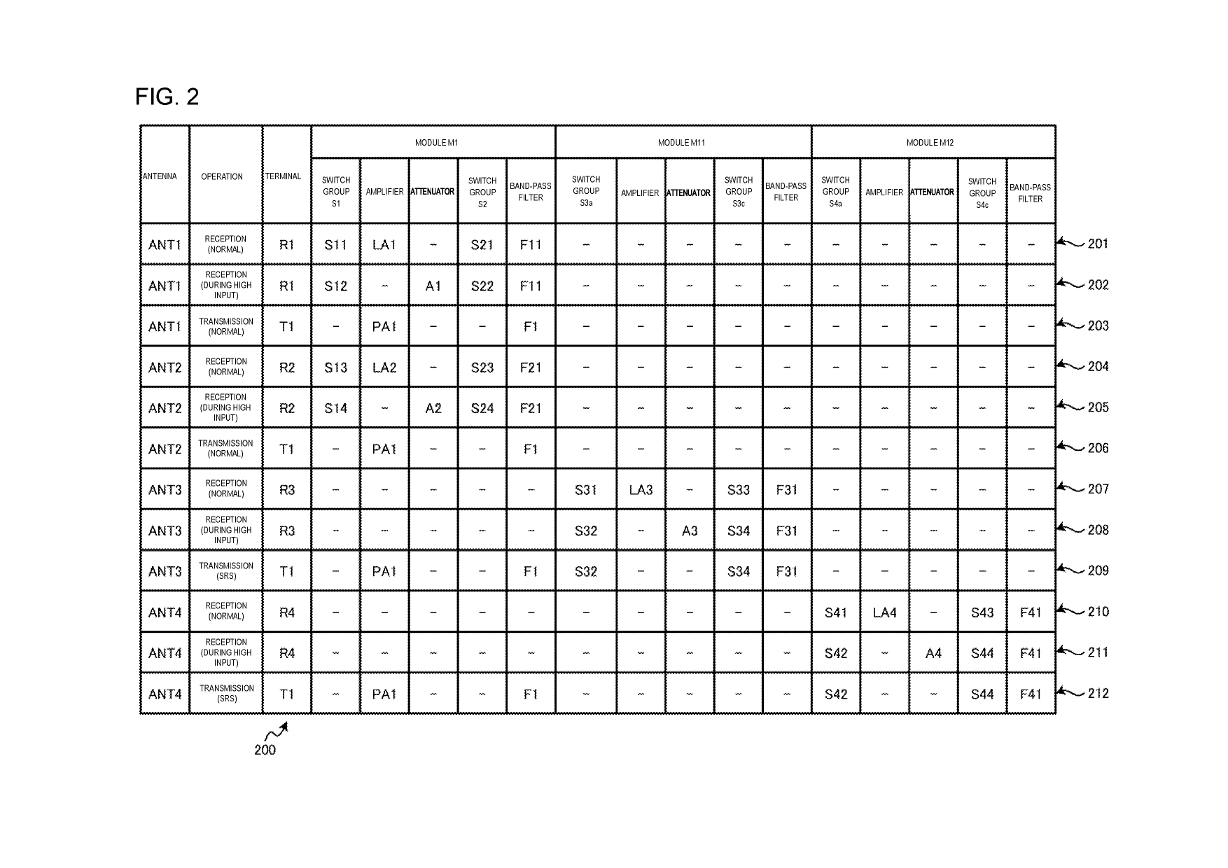

FIG. 2 is a diagram illustrating the operation of the high-frequency signal transmission/reception circuit 1 of the comparative example. FIG. 2 illustrates portions within the modules M1, M11, and M12 through which a high-frequency signal passes in (T) the case of transmission and (R) the case of reception.

(T) The case of transmission includes the following: (T-1) the case of transmission (normal) by the antenna ANT1; (T-2) the case of transmission (normal) by the antenna ANT2; (T-3) the case of transmission (SRS) by the antenna ANT3; and (T-4) the case of transmission (SRS) by the antenna ANT4.

(R) The case of reception includes the following: (R-1-1) the case of reception (normal) by the antenna ANT1; (R-1-2) the case of reception (during high input) by the antenna ANT1; (R-2-1) the case of reception (normal) by the antenna ANT2; (R-2-2) the case of reception (during high input) by the antenna ANT2; (R-3-1) the case of reception (normal) by the antenna ANT3; (R-3-2) the case of reception (during high input) by the antenna ANT3; (R-4-1) the case of reception (normal) by the antenna ANT4; and (R-4-2) the case of reception (during high input) by the antenna ANT4.

(T-1) The case of transmission (normal) by the antenna ANT1 will be described. A third row 203 in Table 200 indicates portions within the high-frequency signal transmission/reception circuit 1 through which a high-frequency transmission signal TXin passes in the case of transmission (normal) by the antenna ANT1.

In the case of transmission (normal) by the antenna ANT1, the TRX switch 11 enters a state in which the antenna ANT1 is connected, based on the control signal Sig1. When the high-frequency transmission signal TXin is inputted to the left-side terminal T1 of the module M1, the power amplifier PA1 amplifies it and outputs the amplified high-frequency transmission signal TXin. The amplified high-frequency transmission signal TXin is inputted to the band-pass filter F1. The band-pass filter F1 allows the high-frequency transmission signal TXin to pass through its passband. The high-frequency transmission signal TXin that has passed through the band-pass filter F1 is inputted to the TRX switch 11. The high-frequency transmission signal TXin that has passed through the TRX switch 11 is outputted to the antenna ANT1.

(T-2) The case of transmission (normal) by the antenna ANT2 will be described. A sixth row 206 in Table 200 indicates portions within the high-frequency signal transmission/reception circuit 1 through which the high-frequency transmission signal TXin passes in the case of transmission (normal) by the antenna ANT2.

In the case of transmission (normal) by the antenna ANT1, the TRX switch 11 enters a state in which the antenna ANT2 is connected, based on the control signal Sig1. When the high-frequency transmission signal TXin is inputted to the left-side terminal T1 of the module M1, the power amplifier PA1 amplifies it and outputs the amplified high-frequency transmission signal TXin. The amplified high-frequency transmission signal TXin is inputted to the band-pass filter F1. The band-pass filter F1 allows the high-frequency transmission signal TXin to pass through its passband. The high-frequency transmission signal TXin that has passed through the band-pass filter F1 is inputted to the TRX switch 11. The high-frequency transmission signal TXin that has passed through the TRX switch 11 is outputted to the antenna ANT2.

(T-3) The case of transmission (SRS) by the antenna ANT3 will be described. A ninth row 209 in Table 200 indicates portions within the high-frequency signal transmission/reception circuit 1 through which the high-frequency transmission signal TXin, which is an SRS signal, passes in the case of transmission (SRS) by the antenna ANT3.

When the high-frequency transmission signal TXin, which is the SRS signal, is inputted to the left-side terminal T1 of the module M1, the power amplifier PA1 amplifies the high-frequency transmission signal TXin and outputs it. The amplified SRS signal is inputted to the band-pass filter F1. The band-pass filter F1 allows the SRS signal to pass through its passband. The SRS signal that has passed through the band-pass filter F1 is inputted to the TRX switch 11.

In the case of transmission (SRS) by the antenna ANT3, the TRX switch 11 is set based on the control signal Sig1; furthermore, the switch 12 is set based on the control signal Sig2, and the SRS signal is inputted to the module M11.

In the module M11, the switch 13 is set based on the control signal Sig30; the switch S32 enters an on state and the switch S31 enters an off state based on the control signal Sig31; and the switch S34 enters an on state and the switch S33 enters an off state based on the control signal Sig32. Accordingly, the SRS signal passes through the attenuator A3 and is inputted to the band-pass filter F31. The band-pass filter F31 allows the SRS signal to pass through its passband. The SRS signal that has passed through the band-pass filter F31 is outputted to the antenna ANT3. Note that the attenuation amount of the attenuator A3 is set to a value that does not attenuate the SRS signal passing therethrough.

The above transmission path is indicated by dashed arrow 100 in FIG. 1. That is, as indicated by dashed arrow 100, the SRS transmission signal is transmitted along the following path: terminal T1, power amplifier PA1, band-pass filter F1, TRX switch 11, switch 12, switch 13, switch S32, attenuator A3, switch S34, band-pass filter F31, and antenna ANT3.

(T-4) The case of transmission (SRS) by the antenna ANT4 will be described. A twelfth row 212 in Table 200 indicates portions within the high-frequency signal transmission/reception circuit 1 through which the high-frequency transmission signal TXin, which is the SRS signal, passes in the case of transmission (SRS) by the antenna ANT4.

When the high-frequency transmission signal TXin, which is the SRS signal, is inputted to the left-side terminal T1 of the module M1, the power amplifier PA1 amplifies the high-frequency transmission signal TXin and outputs it. The amplified SRS signal is inputted to the band-pass filter F1. The band-pass filter F1 allows the SRS signal to pass through its passband. The SRS signal that has passed through the band-pass filter F1 is inputted to the TRX switch 11.

In the case of transmission (SRS) by the antenna ANT4, the TRX switch 11 is set based on the control signal Sig1; furthermore, the switch 12 is set based on the control signal Sig2, and the SRS signal is inputted to the module M12.

In the module M12, the switch 14 is set based on the control signal Sig40; the switch S42 enters an on state and the switch S41 enters an off state based on the control signal Sig41; and the switch S44 enters an on state and the switch S43 enters an off state based on the control signal Sig42. Accordingly, the SRS signal passes through the attenuator A4 and is inputted to the band-pass filter F41. The band-pass filter F41 allows the SRS signal to pass through its passband. The SRS signal that has passed through the band-pass filter F41 is outputted to the antenna ANT4. Note that the attenuation amount of the attenuator A4 is set to a value that does not attenuate the SRS signal passing therethrough.

(R-1-1) The case of reception (normal) by the antenna ANT1 will be described. A first row 201 in Table 200 indicates portions within the high-frequency signal transmission/reception circuit 1 through which a high-frequency reception signal passes in the case of reception (normal) by the antenna ANT1.

In the case of reception (normal) by the antenna ANT1, the TRX switch 11 is set based on the control signal Sig1; the switch S11 enters an on state based on the control signal Sig11; and the switch S21 enters an on state based on the control signal Sig21. The switch S12 enters an off state based on the control signal Sig11, and the switch S22 enters an off state based on the control signal Sig21. When the high-frequency reception signal is inputted from the antenna ANT1, it passes through the TRX switch 11 and is inputted to the band-pass filter F11. The band-pass filter F11 allows the high-frequency reception signal to pass through its passband. The high-frequency reception signal that has passed through the band-pass filter F11 passes through the switch S21 and is inputted to the low-noise amplifier LA1. The low-noise amplifier LA1 amplifies the high-frequency reception signal that has passed through the switch S21. The high-frequency reception signal that has been amplified by the low-noise amplifier LA1 passes through the switch S11 and is outputted from the terminal R1 as a high-frequency reception signal RXout1.

(R-1-2) The case of reception (during high input) by the antenna ANT1 will be described. A second row 202 in Table 200 indicates portions within the high-frequency signal transmission/reception circuit 1 through which a high-frequency reception signal passes in the case of reception (during high input) by the antenna ANT1.

In the case of reception (during high input) by the antenna ANT1, the TRX switch 11 is set based on the control signal Sig1; the switch S12 enters an on state based on the control signal Sig11; and the switch S22 enters an on state based on the control signal Sig21. The switch S11 enters an off state based on the control signal Sig11, and the switch S21 enters an off state based on the control signal Sig21. When the high-frequency reception signal is inputted from the antenna ANT1, it passes through the TRX switch 11 and is inputted to the band-pass filter F11. The band-pass filter F11 allows the high-frequency reception signal to pass through its passband. The high-frequency reception signal that has passed through the band-pass filter F11 passes through the switch S22 and is inputted to the attenuator A1. The attenuator A1 attenuates the high-frequency reception signal that has passed through the switch S22 to an appropriate level. The high-frequency reception signal that has been attenuated by the attenuator A1 passes through the switch S12 and is outputted from the terminal R1 as the high-frequency reception signal RXout1. Note that the attenuation amount of the attenuator A1 is set based on a control signal from a control circuit which is not illustrated.

(R-2-1) The case of reception (normal) by the antenna ANT2 will be described. A fourth row 204 in Table 200 indicates portions within the high-frequency signal transmission/reception circuit 1 through which a high-frequency reception signal passes in the case of reception (normal) by the antenna ANT2.

In the case of reception (normal) by the antenna ANT2, the TRX switch 11 is set based on the control signal Sig1; the switch S13 enters an on state based on the control signal Sig11; and the switch S23 enters an on state based on the control signal Sig21. The switch S14 enters an off state based on the control signal Sig11, and the switch S24 enters an off state based on the control signal Sig21. When the high-frequency reception signal is inputted from the antenna ANT2, it passes through the TRX switch 11 and is inputted to the band-pass filter F21. The band-pass filter F21 allows the high-frequency reception signal to pass through its passband. The high-frequency reception signal that has passed through the band-pass filter F21 passes through the switch S23 and is inputted to the low-noise amplifier LA2. The low-noise amplifier LA2 amplifies the high-frequency reception signal that has passed through the switch S23. The high-frequency reception signal that has been amplified by the low-noise amplifier LA2 passes through the switch S13 and is outputted from the terminal R2 as a high-frequency reception signal RXout2.

(R-2-2) The case of reception (during high input) by the antenna ANT2 will be described. A fifth row 205 in Table 200 indicates portions within the high-frequency signal transmission/reception circuit 1 through which a high-frequency reception signal passes in the case of reception (during high input) by the antenna ANT2.

In the case of reception (during high input) by the antenna ANT2, the TRX switch 11 is set based on the control signal Sig1; the switch S14 enters an on state based on the control signal Sig11; and the switch S24 enters an on state based on the control signal Sig21. The switch S13 enters an off state based on the control signal Sig11, and the switch S23 enters an off state based on the control signal Sig21. When the high-frequency reception signal is inputted from the antenna ANT2, it passes through the TRX switch 11 and is inputted to the band-pass filter F21. The band-pass filter F21 allows the high-frequency reception signal to pass through its passband. The high-frequency reception signal that has passed through the band-pass filter F21 passes through the switch S24 and is inputted to the attenuator A2. The attenuator A2 attenuates the high-frequency reception signal that has passed through the switch S24 to an appropriate level. The high-frequency reception signal attenuated by the attenuator A2 passes through the switch S14 and is outputted from the terminal R2 as the high-frequency reception signal RXout2. The attenuation amount of the attenuator A2 is set based on a control signal from a control circuit which is not illustrated.

(R-3-1) The case of reception (normal) by the antenna ANT3 will be described. A seventh row 207 in Table 200 indicates portions within the high-frequency signal transmission/reception circuit 1 through which a high-frequency reception signal passes in the case of reception (normal) by the antenna ANT3.

In the case of reception (normal) by the antenna ANT3, the switch 13 is set based on the control signal Sig30; the switch S31 enters an on state based on the control signal Sig31; and the switch S33 enters an on state based on the control signal Sig32. The switch S32 enters an off state based on the control signal Sig31, and the switch S24 enters an off state based on the control signal Sig32. When the high-frequency reception signal is inputted from the antenna ANT3, it is inputted to the band-pass filter F31. The band-pass filter F31 allows the high-frequency reception signal to pass through its passband. The high-frequency reception signal that has passed through the band-pass filter F31 passes through the switch S33 and is inputted to the low-noise amplifier LA3. The low-noise amplifier LA3 amplifies the high-frequency reception signal that has passed through the switch S33. The high-frequency reception signal that has been amplified by the low-noise amplifier LA3 passes through the switch S31 and the switch 13 and is outputted from the terminal R3 as a high-frequency reception signal RXout3.

(R-3-2) The case of reception (during high input) by the antenna ANT3 will be described. An eighth row 208 in Table 200 indicates portions within the high-frequency signal transmission/reception circuit 1 through which a high-frequency reception signal passes in the case of reception (during high input) by the antenna ANT3.

In the case of reception (during high input) by the antenna ANT3, the switch 13 is set based on the control signal Sig30; the switch S32 enters an on state based on the control signal Sig31; and the switch S34 enters an on state based on the control signal Sig32. The switch S31 enters an off state based on the control signal Sig31, and the switch S33 enters an off state based on the control signal Sig32. When the high-frequency reception signal is inputted from the antenna ANT3, it is inputted to the band-pass filter F31. The band-pass filter F31 allows the high-frequency reception signal to pass through its passband. The high-frequency reception signal that has passed through the band-pass filter F31 passes through the switch S34 and is inputted to the attenuator A3. The attenuator A3 attenuates the high-frequency reception signal that has passed through the switch S34 to an appropriate level. The high-frequency reception signal that has been attenuated by the attenuator A3 passes through the switch S32 and the switch 13 and is outputted from the terminal R3 as the high-frequency reception signal RXout3. The attenuation amount of the attenuator A3 is set based on a control signal from a control circuit which is not illustrated.

(R-4-1) The case of reception (normal) by the antenna ANT4 (normal) will be described. A tenth row 210 in Table 200 indicates portions within the high-frequency signal transmission/reception circuit 1 through which a high-frequency reception signal passes in the case of reception (normal) by the antenna ANT4.

In the case of reception (normal) by the antenna ANT4, the switch 14 is set based on the control signal Sig40; the switch S41 enters an on state based on the control signal Sig41; and the switch S43 enters an on state based on the control signal Sig42. The switch S42 enters an off state based on the control signal Sig41, and the switch S44 enters an off state based on the control signal Sig42. When the high-frequency reception signal is inputted from the antenna ANT4, it is inputted to the band-pass filter F41. The band-pass filter F41 allows the high-frequency reception signal to pass through its passband. The high-frequency reception signal that has passed through the band-pass filter F41 passes through the switch S43 and is inputted to the low-noise amplifier LA4. The low-noise amplifier LA4 amplifies the high-frequency reception signal that has passed through the switch S43. The high-frequency reception signal that has been amplified by the low-noise amplifier LA4 passes through the switch S41 and the switch 14 and is outputted from the terminal R4 as a high-frequency reception signal RXout4.

(R-4-2) The case of reception (during high input) by the antenna ANT4 will be described. An eleventh row 211 in Table 200 indicates portions within the high-frequency signal transmission/reception circuit 1 through which a high-frequency reception signal passes in the case of reception (during high input) by the antenna ANT4.

In the case of reception (during high input) by the antenna ANT4, the switch 14 is set based on the control signal Sig40; the switch S42 enters an on state based on the control signal Sig41; and the switch S44 enters an on state based on the control signal Sig42. The switch S41 enters an off state based on the control signal Sig41, and the switch S43 enters an off state based on the control signal Sig42. When the high-frequency reception signal is inputted from the antenna ANT4, it is inputted to the band-pass filter F41. The band-pass filter F41 allows the high-frequency reception signal to pass through its passband. The high-frequency reception signal that has passed through the band-pass filter F41 passes through the switch S44 and is inputted to the attenuator A4. The attenuator A4 attenuates the high-frequency reception signal that has passed through the switch S44 to an appropriate level. The high-frequency reception signal that has been attenuated by the attenuator A4 passes through the switch S42 and the switch 14 and is outputted from the terminal R4 as the high-frequency reception signal RXout4. The attenuation amount of the attenuator A4 is set based on a control signal from a control circuit which is not illustrated.

### First Embodiment

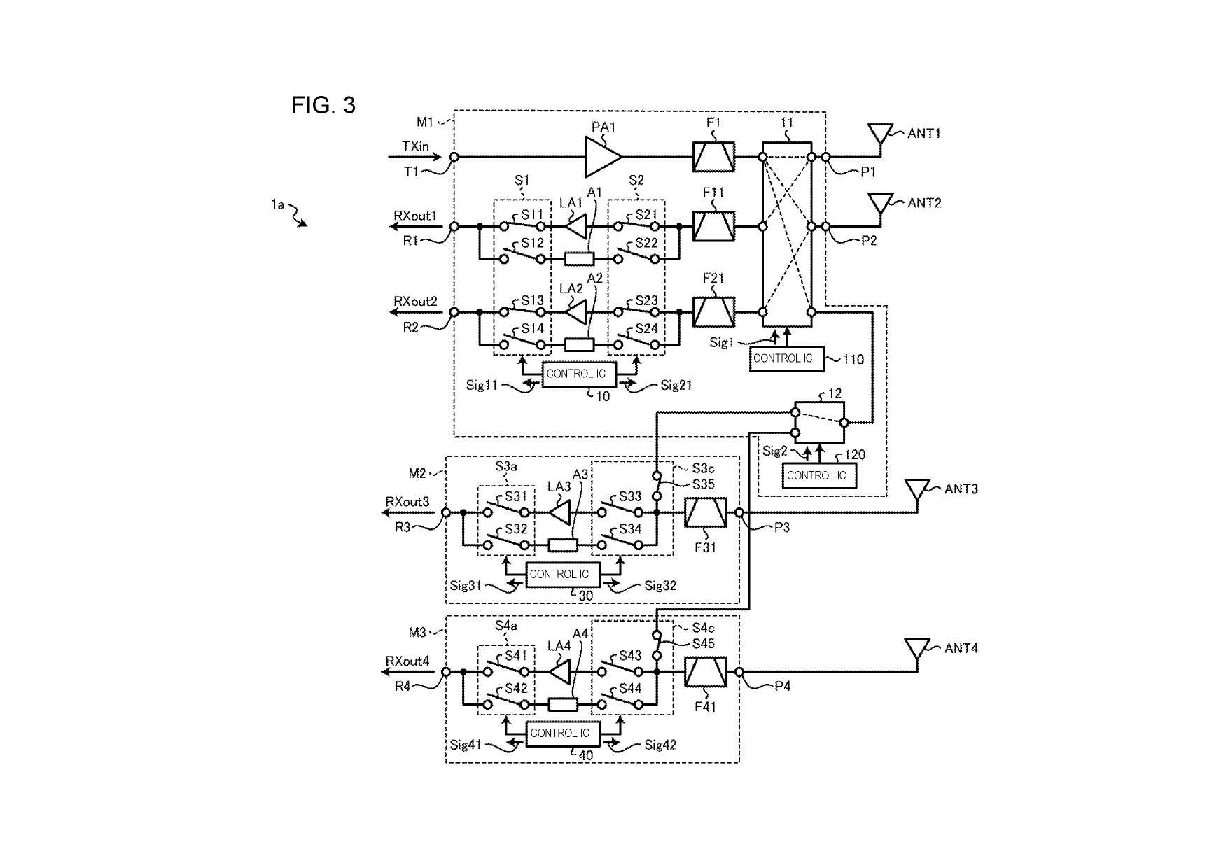

FIG. 3 is a diagram illustrating the configuration of a high-frequency signal transmission/reception circuit 1a of the first embodiment. The high-frequency signal transmission/reception circuit 1a includes modules M1, M2, and M3. The high-frequency signal transmission/reception circuit 1a differs from the high-frequency signal transmission/reception circuit 1 of the comparative example, which has been described with reference to FIG. 1, in the point that the modules M2 and M3 are used instead of the modules M11 and M12. The modules M2 and M3 correspond to a reception circuit of the present disclosure. The terminals P3 and P4 correspond to the reception antenna terminal of the present disclosure. The power amplifier PA1 of the module M1 corresponds to the amplifier of the present disclosure. The terminals P1 and P2 of the module M1 correspond to a transmission/reception antenna terminal of the present disclosure. The TRX switch 11 of the module M1 corresponds to a TRX switch of the present disclosure.

Among the elements of the high-frequency signal transmission/reception circuit 1a, those that are identical to the elements of the high-frequency signal transmission/reception circuit 1 of the comparative example are denoted by the same reference numerals, and description thereof will be omitted as appropriate. For the module M1, the configuration is identical to that of the high-frequency signal transmission/reception circuit 1 of the comparative example. The module M1 corresponds to a signal output unit of the present disclosure.

The high-frequency signal transmission/reception circuit 1a illustrated in FIG. 3 does not include the switches 13 and 14 of the high-frequency signal transmission/reception circuit 1 described with reference to FIG. 1. Additionally, the high-frequency signal transmission/reception circuit 1a includes switch groups S3c and S4c instead of the switch groups S3b and S4b of the high-frequency signal transmission/reception circuit 1.

The switch group S3c includes a switch S35 besides the switches S33 and S34. A first end of the switch S35 is connected to the switch 12, and an SRS signal is inputted to the first end of the switch S35. A second end of the switch S35 is connected between the second ends of the switches S33 and S34 and the first end of the band-pass filter F31. Each switch in the switch group S3c enters an on state or an off state based on the control signal Sig32 inputted from a control IC 30. The switch S35 corresponds to a bypass switch of the present disclosure. The switch 12 corresponds to a changeover switch of the present disclosure. The band-pass filter F31 is disposed between the low noise amplifier LA3, which is the amplifying unit, and the terminal P3. The band-pass filter F31 has a passband including the high-frequency transmission signal TXin. The band-pass filter F31 corresponds to a filter of the present disclosure.

The switch group S4c includes a switch S45 besides the switches S43 and S44. A first end of the switch S45 is connected to the switch 12, and an SRS signal is inputted to the first end of the switch S45. A second end of the switch S45 is connected between the second ends of the switches S43 and S44 and the first end of the band-pass filter F41. Each switch in the switch group S4c enters an on state or an off state based on the control signal Sig42 inputted from a control IC 40. The switch S45 corresponds to the bypass switch of the present disclosure. The band-pass filter F41 is disposed between the low noise amplifier LA4, which is the amplifying unit, and the terminal P4. The band-pass filter F41 has a passband including the high-frequency transmission signal TXin. The band-pass filter F41 corresponds to the filter of the present disclosure.

According to the above configuration, by switching the switch 12 in response to the control signal Sig2, it is possible to input the SRS signal outputted from the TRX switch 11 to the module M2. The SRS signal inputted to the module M2 is transmitted from the antenna ANT3 via the switch S35 and the band-pass filter F31. Additionally, by switching the switch 12 in response to the control signal Sig2, it is possible to input the SRS signal outputted from the TRX switch 11 to the module M3. The SRS signal inputted to the module M3 is transmitted from the antenna ANT4 via the switch S45 and the band-pass filter F41. That is, the switch 12 selects a connection of one of the reception circuits M2 and M3 with the TRX switch 11. Then, the switch 12 inputs the SRS signal between one of the terminals P3 and P4 and the amplifying unit LA3 or the amplifying unit LA4 corresponding to the terminal P3 or the terminal P4. Accordingly, the SRS signal is amplified by the power amplifier PA1 which amplifies a transmission signal, and is transmitted via the TRX switch 11, the switch 12, and the bypass switch S35 or S45, without passing through the low-noise amplifiers LA3 and LA4 which amplify reception signals, and via the terminal P3 or P4.

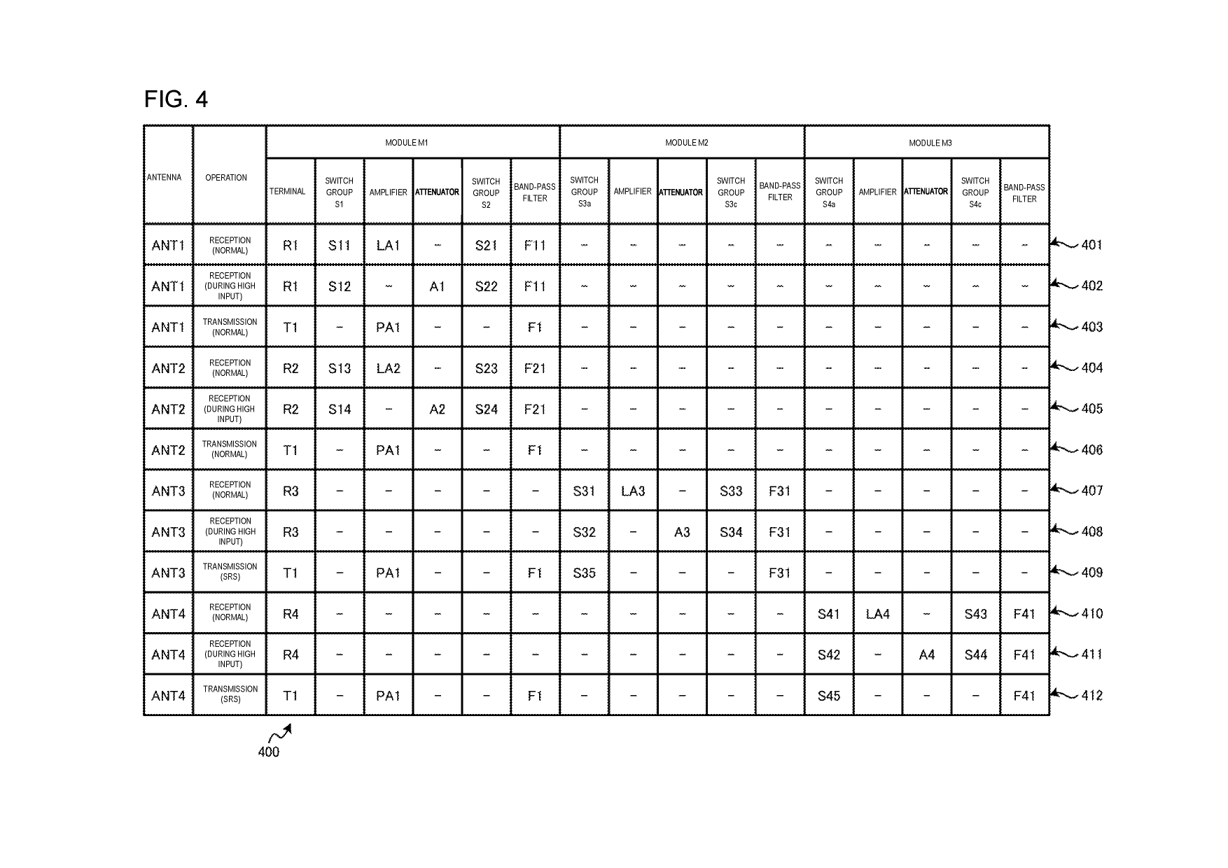

FIG. 4 is a diagram illustrating the operation of the high-frequency signal transmission/reception circuit 1a of the first embodiment. FIG. 4 illustrates portions within the modules M1, M2, and M3 through which a high-frequency signal passes in (T) the case of transmission and (R) the case of reception.

(T) The case of transmission includes the following: (T-1) the case of transmission (normal) by the antenna ANT1; (T-2) the case of transmission (normal) by the antenna ANT2; (T-3) the case of transmission (SRS) by the antenna ANT3; and (T-4) the case of transmission (SRS) by the antenna ANT4.

(R) The case of reception includes the following: (R-1-1) the case of reception (normal) by the antenna ANT1; (R-1-2) the case of reception (during high input) by the antenna ANT1; (R-2-1) the case of reception (normal) by the antenna ANT2; (R-2-2) the case of reception (during high input) by the antenna ANT2; (R-3-1) the case of reception (normal) by the antenna ANT3; (R-3-2) the case of reception (during high input) by the antenna ANT3; (R-4-1) the case of reception (normal) by the antenna ANT4; and (R-4-2) the case of reception (during high input) by the antenna ANT4.

In the case of (T-1) transmission (normal) by the antenna ANT1, a third row 403 in Table 400 indicates portions within the high-frequency signal transmission/reception circuit 1a through which a high-frequency reception signal passes in the case of transmission (normal) by the antenna ANT1. In this case, the operation of the module M1 is the same as that of the high-frequency signal transmission/reception circuit 1 of the comparative example.

In the case of (T-2) transmission (normal) by the antenna ANT2, a sixth row 406 in Table 400 indicates portions within the high-frequency signal transmission/reception circuit 1a through which a high-frequency reception signal passes in the case of transmission (normal) by the antenna ANT2. In this case, the operation of the module M1 is the same as that of the high-frequency signal transmission/reception circuit 1 of the comparative example.

(T-3) The case of transmission (SRS) by the antenna ANT3 will be described. A ninth row 409 in Table 400 indicates portions within the high-frequency signal transmission/reception circuit 1a through which the high-frequency transmission signal TXin, which is the SRS signal, passes in the case of transmission (SRS) by the antenna ANT3.

When the high-frequency transmission signal TXin, which is the SRS signal, is inputted to the left-side terminal T1 of the module M1, the power amplifier PA1 amplifies the high-frequency transmission signal TXin and outputs it. The amplified SRS signal is inputted to the band-pass filter F1. The band-pass filter F1 allows the SRS signal to pass through its passband. The SRS signal that has passed through the band-pass filter F1 is inputted to the TRX switch 11.

In the case of transmission (SRS) by the antenna ANT3, the TRX switch 11 is set based on the control signal Sig1; furthermore, the switch 12 is set based on the control signal Sig2, and the SRS signal is inputted to the module M2.

In the module M2, the switch S35 enters an on state and the switches S33 and S34 enter an off state based on the control signal Sig32. Accordingly, the SRS signal is inputted to the band-pass filter F31. That is, the SRS signal is inputted to the band-pass filter F31, which is close to the antenna ANT3 of the module M3. This input position differs from that of the comparative example. The band-pass filter F31 allows the SRS signal to pass through its passband. The SRS signal that has passed through the band-pass filter F31 is outputted to the antenna ANT3.

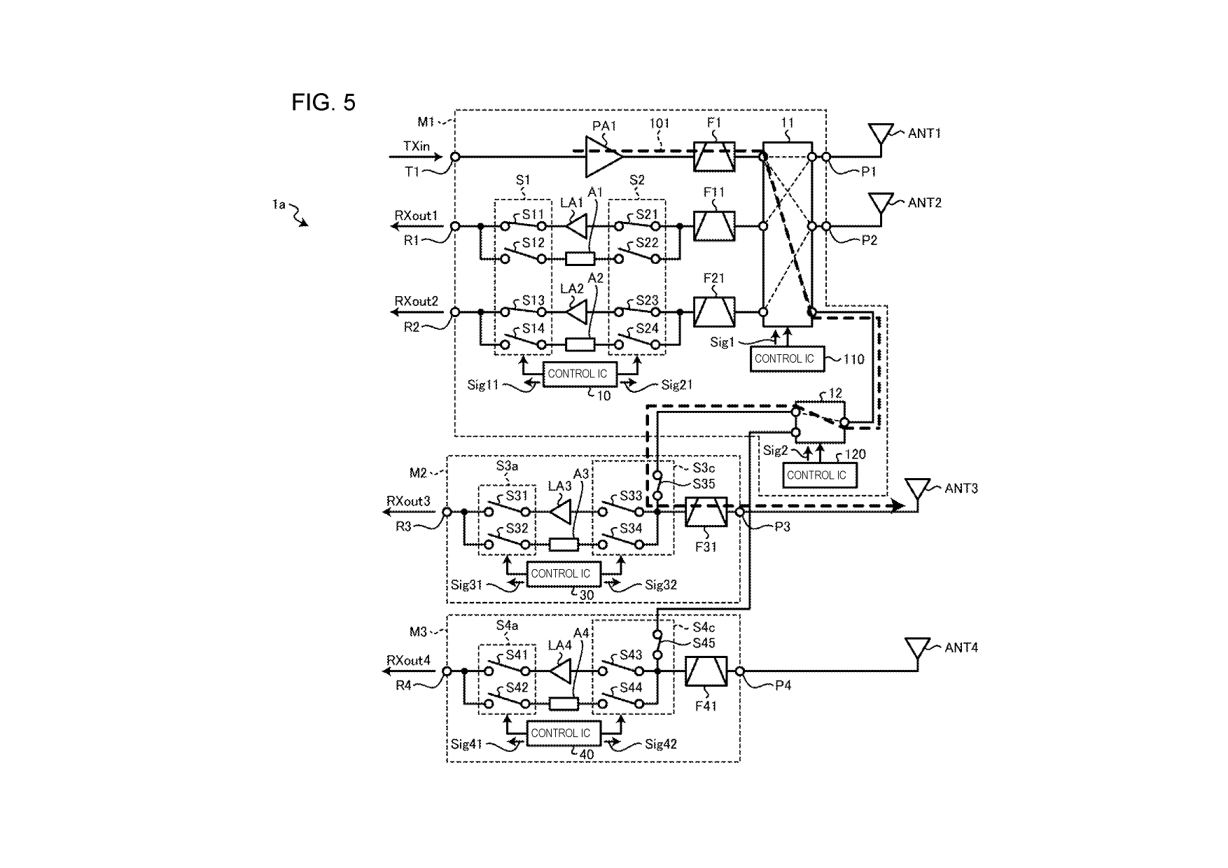

FIG. 5 is a diagram illustrating an example of the transmission path for the SRS signal. In the case of transmitting the SRS signal from the antenna ANT3, the signal follows the path indicated by dashed arrow 101 in FIG. 5. That is, as indicated by dashed arrow 101, the SRS transmission signal is transmitted along the following path: terminal T1, power amplifier PA1, band-pass filter F1, TRX switch 11, switch 12, switch S35, band-pass filter F31, and antenna ANT3.

(T-4) The case of transmission (SRS) by the antenna ANT4 will be described. Referring back to FIG. 4, a twelfth row 412 in Table 400 indicates portions within the high-frequency signal transmission/reception circuit 1a through which the high-frequency transmission signal TXin, which is the SRS signal, passes in the case of transmission (SRS) by the antenna ANT4.

When the high-frequency transmission signal TXin, which is the SRS signal, is inputted to the left-side terminal T1 of the module M1, the power amplifier PA1 amplifies the high-frequency transmission signal TXin and outputs it. The amplified SRS signal is inputted to the band-pass filter F1. The band-pass filter F1 allows the SRS signal to pass through its passband. The SRS signal that has passed through the band-pass filter F1 is inputted to the TRX switch 11.

In the case of transmission (SRS) by the antenna ANT4, the TRX switch 11 is set based on the control signal Sig1; furthermore, the switch 12 is set based on the control signal Sig2, and the SRS signal is inputted to the module M3.

In the module M3, the switch S45 enters an on state, and the switches S43 and S44 enter an off state based on the control signal Sig42. Accordingly, the SRS signal is inputted to the band-pass filter F41. That is, the SRS signal is inputted to the band-pass filter F41, which is close to the antenna ANT4 of the module M4. This input position differs from that of the comparative example. The band-pass filter F41 allows the SRS signal to pass through its passband. The SRS signal that has passed through the band-pass filter F41 is outputted to the antenna ANT4.

(R-1-1) The case of reception (normal) by the antenna ANT1 corresponds to a first row 401 in Table 400. The first row 401 in Table 400 indicates portions of the high-frequency signal transmission/reception circuit 1a through which a high-frequency reception signal passes in the case of reception (normal) by the antenna ANT1. The operation in this case is the same as that in the case of the first row 201 in Table 200 in FIG. 2.

(R-1-2) The case of reception (during high input) by the antenna ANT1 corresponds to a second row 402 in Table 400. The second row 402 in Table 400 indicates portions of the high-frequency signal transmission/reception circuit 1a through which a high-frequency reception signal passes in the case of reception (during high input) by the antenna ANT1. The operation in this case is the same as that in the case of the second row 202 in Table 200 in FIG. 2.

(R-2-1) The case of reception (normal) by the antenna ANT2 corresponds to a fourth row 404 in Table 400. The fourth row 404 in Table 400 indicates portions of the high-frequency signal transmission/reception circuit 1a through which a high-frequency reception signal passes in the case of reception (normal) by the antenna ANT2. The operation in this case is the same as that in the case of the fourth row 204 in Table 200 in FIG. 2.

(R-2-2) The case of reception (during high input) by the antenna ANT2 corresponds to a fifth row 405 in Table 400. The fifth row 405 in Table 400 indicates portions of the high-frequency signal transmission/reception circuit 1a through which a high-frequency reception signal passes in the case of reception (during high input) by the antenna ANT2. The operation in this case is the same as that in the case of the fifth row 205 in Table 200 in FIG. 2.

(R-3-1) The case of reception (normal) by the antenna ANT3 corresponds to a seventh row 407 in Table 400. The seventh row 407 in Table 400 indicates portions of the high-frequency signal transmission/reception circuit 1a through which a high-frequency reception signal passes in the case of reception (normal) by the antenna ANT3. The operation in this case is the same as that in the case of the seventh row 207 in Table 200 in FIG. 2.

(R-3-2) The case of reception (during high input) by the antenna ANT3 corresponds to an eighth row 408 in Table 400. The eighth row 408 in Table 400 indicates portions of the high-frequency signal transmission/reception circuit 1a through which a high-frequency reception signal passes in the case of reception (during high input) by the antenna ANT3. The operation in this case is the same as that in the case of the eighth row 208 in Table 200 in FIG. 2.

(R-4-1) The case of reception (normal) by the antenna ANT4 corresponds to a tenth row 410 in Table 400. The tenth row 410 in Table 400 indicates portions of the high-frequency signal transmission/reception circuit 1a through which a high-frequency reception signal passes in the case of reception (normal) by the antenna ANT4. The operation in this case is the same as that in the case of the tenth row 210 in Table 200 in FIG. 2.

(R-4-2) The case of reception (during high input) by the antenna ANT4 corresponds to an eleventh row 411 in Table 400. The eleventh row 411 in Table 400 indicates portions of the high-frequency signal transmission/reception circuit 1a through which a high-frequency reception signal passes in the case of reception (during high input) by the antenna ANT4. The operation in this case is the same as that in the case of the eleventh row 211 in Table 200 in FIG. 2.

According to the high-frequency signal transmission/reception circuit 1a of the first embodiment, it is possible to suppress an increase in circuit scale by adopting a changeover switch for inputting an SRS signal between the reception antenna and the amplifying unit. In addition, by inputting an SRS signal at a position that does not pass through the path that bypasses the low-noise amplifier, it is not necessary to configure the path that bypasses the low-noise amplifier so as to support high power.

Note that at least two of the TRX switch 11, the changeover switch 12, the switch S35 or S45, and the low-noise amplifiers LA3 and LA4 which amplify a reception signal may be provided on the same substrate. By providing them on the same substrate, they can be handled as a module.

### Second Embodiment

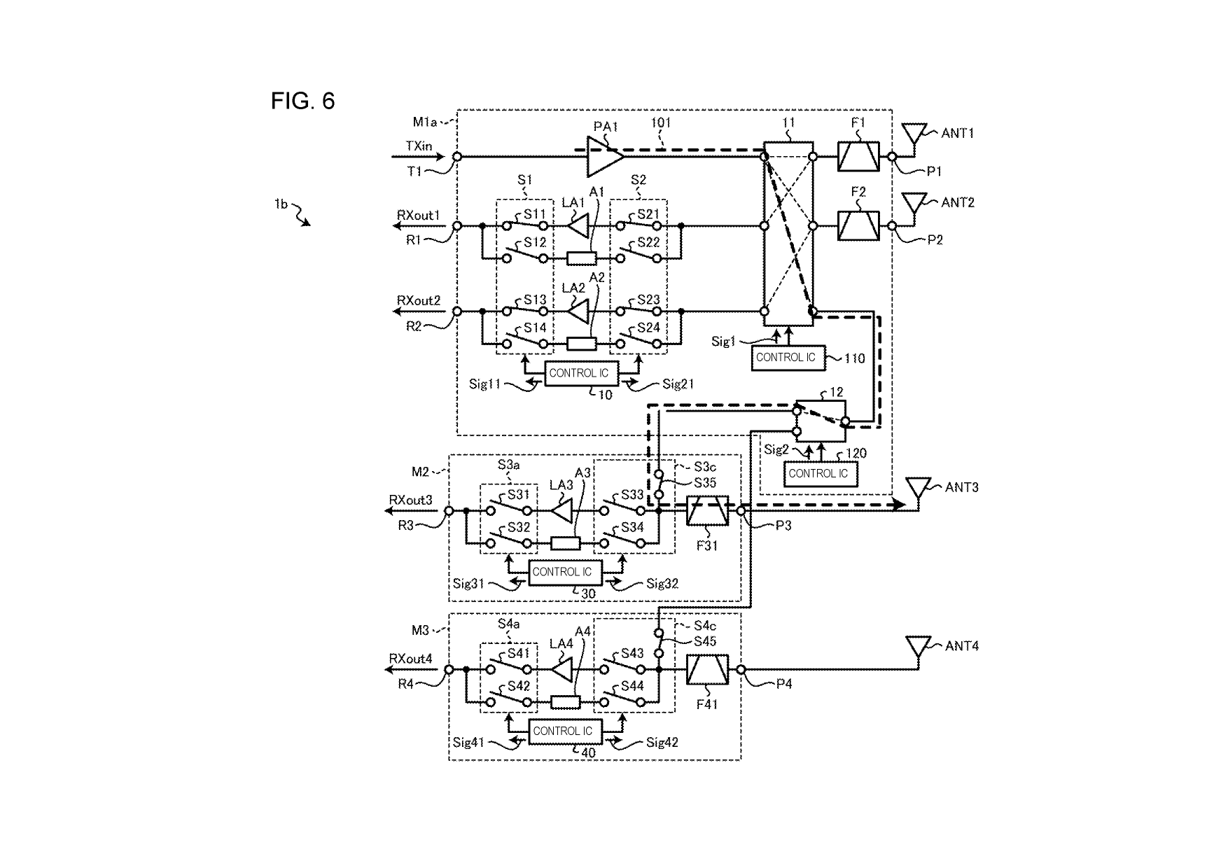

FIG. 6 is a diagram illustrating the configuration of a high-frequency signal transmission/reception circuit 1b of a second embodiment. In the high-frequency signal transmission/reception circuit 1b illustrated in FIG. 6, a module M1a is used instead of the module M1 of the high-frequency signal transmission/reception circuit 1a described with reference to FIG. 3. In the module M1a, the positions of band-pass filters differ from those in the module M1 of the high-frequency signal transmission/reception circuit 1a described with reference to FIG. 3.

That is, in the high-frequency signal transmission/reception circuit 1b, the band-pass filter F1 is provided between the TRX switch 11 and the antenna ANT1, and the band-pass filter F2 is provided between the TRX switch 11 and the antenna ANT2. In the high-frequency signal transmission/reception circuit 1a, the band-pass filter F1 is provided between the TRX switch 11 and the antenna ANT1. In contrast, in the high-frequency signal transmission/reception circuit 1b, no band-pass filter is provided between the power amplifier PA1 and the TRX switch 11.

Additionally, in the high-frequency signal transmission/reception circuit 1a, the band-pass filters F11 and F21 are provided between the TRX switch 11 and the switch group S2. In contrast, in the high-frequency signal transmission/reception circuit 1b, no band-pass filter is provided between the TRX switch 11 and the switch group S2.

In the path indicated by dashed arrow 101 in FIG. 6, the band-pass filter through which the signal passes is the band-pass filter F31 in the module M2. Therefore, in the case of transmitting the SRS signal by the antenna ANT3, the number of band-pass filters through which the signal passes is smaller than in the case of the high-frequency signal transmission/reception circuit 1a. For this reason, it is possible to reduce the degradation of the SRS signal.

Note that, in the case of transmission (normal) by the antenna ANT1, the transmission signal that has passed through the TRX switch 11 passes through the band-pass filter F1; thus, the transmission signal outputted from the antenna ANT1 is equivalent to the case of FIG. 3. Additionally, in the case of transmission (normal) by the antenna ANT2, the transmission signal that has passed through the TRX switch 11 passes through the band-pass filter F2; thus, the transmission signal outputted from the antenna ANT2 is equivalent to the case of FIG. 3.

According to the high-frequency signal transmission/reception circuit 1b of the second embodiment, it is possible to suppress an increase in circuit scale by adopting a changeover switch for inputting an SRS signal between the reception antenna and the amplifying unit. In addition, by inputting an SRS signal at a position that does not pass through the path that bypasses the low-noise amplifier, it is not necessary to configure the path that bypasses the low-noise amplifier so as to support high power.

Furthermore, in the high-frequency signal transmission/reception circuit 1b of the second embodiment, it is possible to reduce the number of band-pass filters as compared to the first embodiment, thereby suppressing an increase in circuit scale. It is also possible to reduce the number of band-pass filters through which the signal passes, thereby reducing the degradation of the SRS signal.

### Third Embodiment

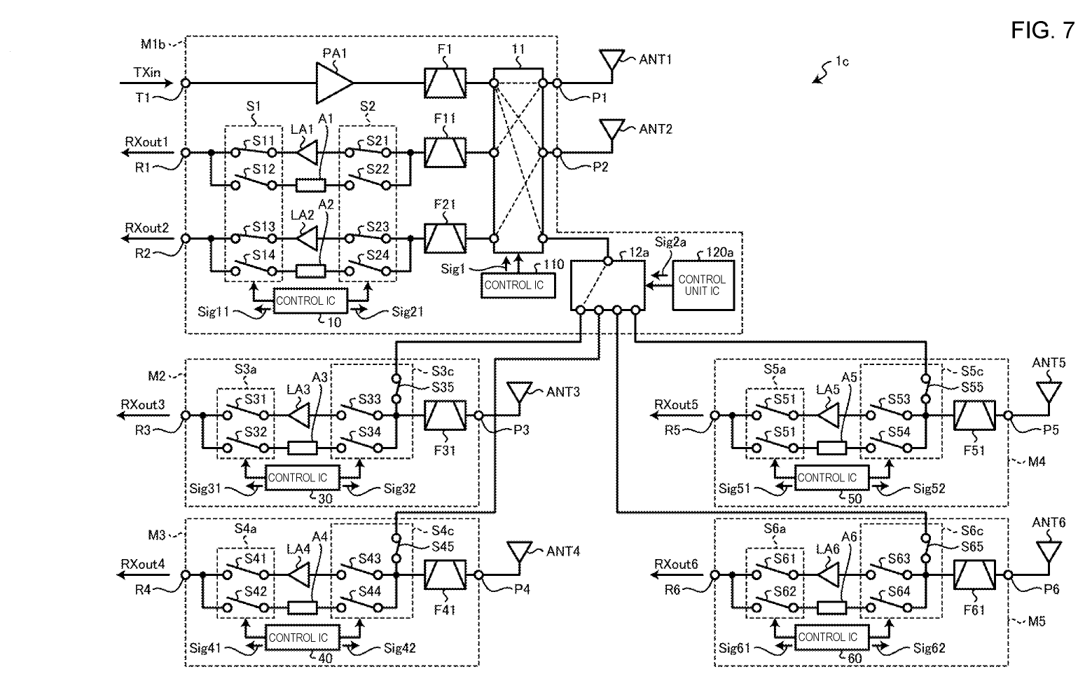

FIG. 7 is a diagram illustrating the configuration of a high-frequency signal transmission/reception circuit 1c of a third embodiment. The high-frequency signal transmission/reception circuit 1c illustrated in FIG. 7 has a configuration in which antennas ANT5 and ANT6 and modules M4 and M5 are added to the high-frequency signal transmission/reception circuit 1a described with reference to FIG. 3, and a module M1b is used instead of the module M1. The high-frequency signal transmission/reception circuit 1c supports 2T6R in which, in the case of normal communication, radio waves are transmitted from the antennas ANT1 and ANT2, and radio waves are received by the antennas ANT1, ANT2, ANT3, ANT4, ANT5, and ANT6. With the increase in the number of antennas and modules, in the module M1b, a switch 12a and a control IC 120a are used, instead of the switch 12 and the control IC 120 of the module M1. The switch 12a corresponds to a selection switch of the present disclosure.

The module M4 includes terminals R5 and P5, a switch group S5a, a low-noise amplifier LA5, an attenuator A5, a switch group S5c, a band-pass filter F51, and a control IC 50. The switch group S5a includes switches S51 and S52. The switch group S5c includes switches S53, S54, and S55.

A first end of the switch S51 and a first end of the switch S52 are connected to the terminal R5. A second end of the switch S51 is electrically connected to an output terminal of the low-noise amplifier LA5. An input terminal of the low-noise amplifier LA5 is electrically connected to a first end of the switch S53. A second end of the switch S52 is electrically connected to a first end of the attenuator A5. A second end of the attenuator A5 is electrically connected to a first end of the switch S54. A second end of the switch S53 and a second end of the switch S54 are electrically connected to a first end of the band-pass filter F51. A second end of the band-pass filter F51 is electrically connected to the antenna ANT5.

Each switch in the switch group S5a enters an on state or an off state based on a control signal Sig51 inputted from the control IC 50. Each switch in the switch group S5c enters an on state or an off state based on a control signal Sig52 inputted from the control IC 50.

The module M5 includes terminals R6 and P6, a switch group S6a, a low-noise amplifier LA6, an attenuator A6, a switch group S6c, a band-pass filter F61, and a control IC 60. The switch group S6a includes switches S61 and S62. The switch group S6c includes switches S63, S64, and S65.

A first end of the switch S61 and a first end of the switch S62 are connected to the terminal R6. A second end of the switch S61 is electrically connected to an output terminal of the low-noise amplifier LA6. An input terminal of the low-noise amplifier LA6 is electrically connected to a first end of the switch S63. A second end of the switch S62 is electrically connected to a first end of the attenuator A6. A second end of the attenuator A6 is electrically connected to a first end of the switch S64. A second end of the switch S63 and a second end of the switch S64 are electrically connected to a first end of the band-pass filter F61. A second end of the band-pass filter F61 is electrically connected to the antenna ANT6.

Each switch in the switch group S6a enters an on state or an off state based on a control signal Sig61 inputted from the control IC 60. Each switch in the switch group S6c enters an on state or an off state based on a control signal Sig62 inputted from the control IC 60.

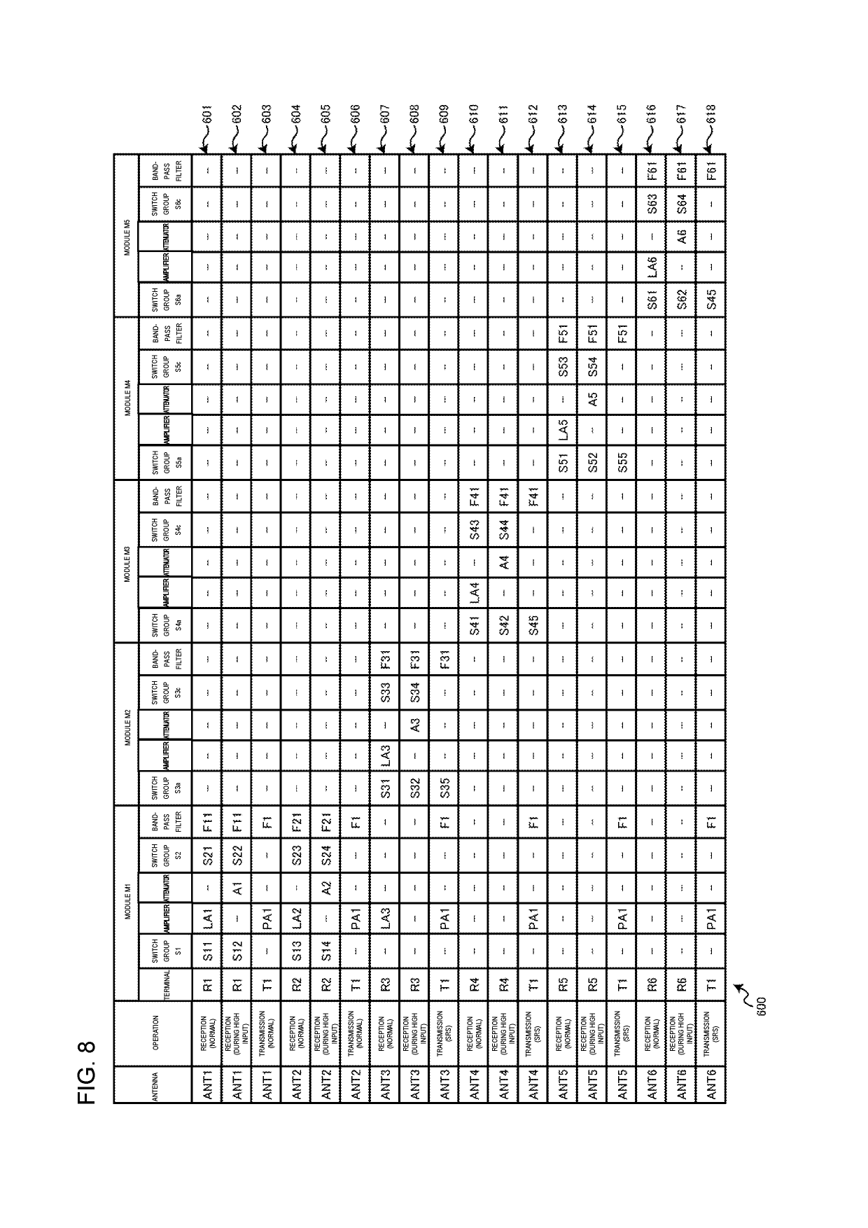

FIG. 8 is a diagram illustrating the operation of the high-frequency signal transmission/reception circuit 1c of the third embodiment. FIG. 8 illustrates portions within the modules M1b, M2, M3, M4, and M5 through which a high-frequency signal passes in (T) the case of transmission and (R) the case of reception.

(T) The case of transmission includes the following: (T-1) the case of transmission (normal) by the antenna ANT1; (T-2) the case of transmission (normal) by the antenna ANT2; (T-3) the case of transmission (SRS) by the antenna ANT3; (T-4) the case of transmission (SRS) by the antenna ANT4; (T-5) the case of transmission (SRS) by the antenna ANT5; and (T-6) the case of transmission (SRS) by the antenna ANT6.

(R) The case of reception includes the following: (R-1-1) the case of reception (normal) by the antenna ANT1; (R-1-2) the case of reception (during high input) by the antenna ANT1; (R-2-1) the case of reception (normal) by the antenna ANT2; (R-2-2) the case of reception (during high input) by the antenna ANT2; (R-3-1) the case of reception (normal) by the antenna ANT3; (R-3-2) the case of reception (during high input) by the antenna ANT3; (R-4-1) the case of reception (normal) by the antenna ANT4; (R-4-2) the case of reception (during high input) by the antenna ANT4; (R-5-1) the case of reception (normal) by the antenna ANT5; (R-5-2) the case of reception (during high input) by the antenna ANT5; (R-6-1) the case of reception (normal) by the antenna ANT6; and (R-6-2) the case of reception (during high input) by the antenna ANT6.

In the case of (T-1) transmission (normal) by the antenna ANT1, a third row 603 in Table 600 indicates portions within the high-frequency signal transmission/reception circuit 1c through which a high-frequency reception signal passes in the case of transmission (normal) by the antenna ANT1. In this case, the operation of the module M1 is the same as that of the high-frequency signal transmission/reception circuit 1a of the first embodiment.

In the case of (T-2) transmission (normal) by the antenna ANT2, a sixth row 606 in Table 600 indicates portions within the high-frequency signal transmission/reception circuit 1c through which a high-frequency reception signal passes in the case of transmission (normal) by the antenna ANT2. In this case, the operation of the module M1 is the same as that of the high-frequency signal transmission/reception circuit 1a of the first embodiment.

(T-3) The case of transmission (SRS) by the antenna ANT3 will be described. A ninth row 609 in Table 600 indicates portions of the high-frequency signal transmission/reception circuit 1c through which the high-frequency transmission signal TXin, which is the SRS signal, passes in the case of transmission (SRS) by the antenna ANT3. In this case, the operation of the module M1 and the module M2 is the same as that of the high-frequency signal transmission/reception circuit 1a of the first embodiment.

(T-4) The case of transmission (SRS) by the antenna ANT4 will be described. A twelfth row 612 in Table 600 indicates portions of the high-frequency signal transmission/reception circuit 1c through which the high-frequency transmission signal TXin, which is the SRS signal, passes in the case of transmission (SRS) by the antenna ANT4. In this case, the operation of the module M1 and the module M3 is the same as that of the high-frequency signal transmission/reception circuit 1a of the first embodiment.

(T-5) The case of transmission (SRS) by the antenna ANT5 will be described. A fifteenth row 615 in Table 600 indicates portions of the high-frequency signal transmission/reception circuit 1c through which the high-frequency transmission signal TXin, which is the SRS signal, passes in the case of transmission (SRS) by the antenna ANT5. In this case, the operation of the modules M1 and M4 is as follows. That is, when the high-frequency transmission signal TXin, which is the SRS signal, is inputted to the left-side terminal T1 of the module M1, the power amplifier PA1 amplifies the high-frequency transmission signal TXin and outputs it. The amplified SRS signal is inputted to the band-pass filter F1. The band-pass filter F1 allows the SRS signal to pass through its passband. The SRS signal that has passed through the band-pass filter F1 is inputted to the TRX switch 11.

In the case of transmission (SRS) by the antenna ANT5, the TRX switch 11 is set based on the control signal Sig1; furthermore, the switch 12a is set based on the control signal Sig2a, and the SRS signal is inputted to the module M4. The switch 12a corresponds to the selection switch of the present disclosure.

In the module M4, the switch S55 enters an on state and the switches S53 and S54 enter an off state based on the control signal Sig52. Accordingly, the SRS signal is inputted to the band-pass filter F51. That is, the SRS signal is inputted to the band-pass filter F51, which is close to the antenna ANT5 of the module M4. The band-pass filter F51 allows the SRS signal to pass through its passband. The SRS signal that has passed through the band-pass filter F51 is outputted to the antenna ANT5.

(T-6) The case of transmission (SRS) by the antenna ANT6 will be described. An eighteenth row 618 in Table 600 indicates portions of the high-frequency signal transmission/reception circuit 1c through which the high-frequency transmission signal TXin, which is the SRS signal, passes in the case of transmission (SRS) by the antenna ANT6. In this case, the operation of the modules M1 and M5 is as follows. That is, when the high-frequency transmission signal TXin, which is the SRS signal, is inputted to the left-side terminal T1 of the module M1, the power amplifier PA1 amplifies the high-frequency transmission signal TXin and outputs it. The amplified SRS signal is inputted to the band-pass filter F1. The band-pass filter F1 allows the SRS signal to pass through its passband. The SRS signal that has passed through the band-pass filter F1 is inputted to the TRX switch 11.

In the case of transmission (SRS) by the antenna ANT6, the TRX switch 11 is set based on the control signal Sig1; furthermore, the switch 12a is set based on the control signal Sig2a, and the SRS signal is inputted to the module M5. The switch 12a corresponds to the selection switch of the present disclosure.

In the module M5, the switch S65 enters an on state and the switches S63 and S64 enter an off state based on the control signal Sig62. Accordingly, the SRS signal is inputted to the band-pass filter F61. That is, the SRS signal is inputted to the band-pass filter F61, which is close to the antenna ANT5 of the module M5. The band-pass filter F61 allows the SRS signal to pass through its passband. The SRS signal that has passed through the band-pass filter F61 is outputted to the antenna ANT6.

(R-1-1) The case of reception (normal) by the antenna ANT1 corresponds to a first row 601 in Table 600. The first row 601 in Table 600 indicates portions of the high-frequency signal transmission/reception circuit 1c through which a high-frequency reception signal passes in the case of reception (normal) by the antenna ANT1. In this case, the operation of the module M1b is the same as that of the module M1 of the high-frequency signal transmission/reception circuit 1a.

(R-1-2) The case of reception (during high input) by the antenna ANT1 corresponds to a second row 602 in Table 600. The second row 602 in Table 600 indicates portions of the high-frequency signal transmission/reception circuit 1c through which a high-frequency reception signal passes in the case of reception (during high input) by the antenna ANT1. In this case, the operation of the module M1b is the same as that of the module M1 of the high-frequency signal transmission/reception circuit 1a.

(R-2-1) The case of reception (normal) by the antenna ANT2 corresponds to a fourth row 604 in Table 600. The fourth row 604 in Table 600 indicates portions of the high-frequency signal transmission/reception circuit 1c through which a high-frequency reception signal passes in the case of reception (normal) by the antenna ANT2. In this case, the operation of the module M1b is the same as that of the module M1 of the high-frequency signal transmission/reception circuit 1a.

(R-2-2) The case of reception (during high input) by the antenna ANT2 corresponds to a fifth row 605 in Table 600. The fifth row 605 in Table 600 indicates portions of the high-frequency signal transmission/reception circuit 1c through which a high-frequency reception signal passes in the case of reception (during high input) by the antenna ANT2. In this case, the operation of the module M1b is the same as that of the module M1 of the high-frequency signal transmission/reception circuit 1a.

(R-3-1) The case of reception (normal) by the antenna ANT3 corresponds to a seventh row 607 in Table 600. The seventh row 607 in Table 600 indicates portions of the high-frequency signal transmission/reception circuit 1c through which a high-frequency reception signal passes in the case of reception (normal) by the antenna ANT3. In this case, the operation of the modules M1b and M2 is the same as that of the modules M1 and M2 of the high-frequency signal transmission/reception circuit 1a.

(R-3-2) The case of reception (during high input) by the antenna ANT3 corresponds to an eighth row 608 in Table 600. The eighth row 608 in Table 600 indicates portions of the high-frequency signal transmission/reception circuit 1c through which a high-frequency reception signal passes in the case of reception (during high input) by the antenna ANT3. In this case, the operation of the modules M1b and M2 is the same as that of the modules M1 and M2 of the high-frequency signal transmission/reception circuit 1a.

(R-4-1) The case of reception (normal) by the antenna ANT4 (normal) corresponds to a tenth row 610 in Table 600. The tenth row 610 in Table 600 indicates portions of the high-frequency signal transmission/reception circuit 1c through which a high-frequency reception signal passes in the case of reception (normal) by the antenna ANT4. In this case, the operation of the modules M1b and M3 is the same as that of the modules M1 and M3 of the high-frequency signal transmission/reception circuit 1a.

(R-4-2) The case of reception (during high input) by the antenna ANT4 corresponds to an eleventh row 611 in Table 600. The eleventh row 611 in Table 600 indicates portions of the high-frequency signal transmission/reception circuit 1c through which a high-frequency reception signal passes in the case of reception (during high input) by the antenna ANT4. In this case, the operation of the modules M1b and M3 is the same as that of the modules M1 and M3 of the high-frequency signal transmission/reception circuit 1a.

(R-5-1) The case of reception (normal) by the antenna ANT5 will be described. A thirteenth row 613 in Table 600 indicates portions of the high-frequency signal transmission/reception circuit 1c through which a high-frequency reception signal passes in the case of reception (normal) by the antenna ANT5.

In the case of reception (normal) by the antenna ANT5, the switch S51 is set to an on state based on the control signal Sig51 inputted from the control IC 50. Additionally, the switch S53 is set to an on state based on the control signal Sig52 inputted from the control IC 50. The switch S52 is set to an off state based on the control signal Sig51 inputted from the control IC 50. The switch S54 is set to an off state based on the control signal Sig52 inputted from the control IC 50.

The high-frequency reception signal received by the antenna ANT5 is inputted to the band-pass filter F51. The band-pass filter F51 allows the high-frequency reception signal to pass through its passband. The high-frequency reception signal that has passed through the band-pass filter F51 is inputted to the low-noise amplifier LA5 via the switch 53.

The low-noise amplifier LA5 amplifies the high-frequency reception signal that has passed through the switch S53. The high-frequency reception signal that has been amplified by the low-noise amplifier LA5 passes through the switch S51 and is outputted from the terminal R5 as a high-frequency reception signal RXout5.

(R-5-2) The case of reception (during high input) by the antenna ANT5 will be described. A fourteenth row 614 in Table 600 indicates portions of the high-frequency signal transmission/reception circuit 1c through which a high-frequency reception signal passes in the case of reception (during high input) by the antenna ANT5.

In the case of reception (during high input) by the antenna ANT5, the switch S52 is set to an on state based on the control signal Sig51 inputted from the control IC 50. Additionally, the switch S54 is set to an on state based on the control signal Sig52 inputted from the control IC 50. The switch S51 is set to an off state based on the control signal Sig51 inputted from the control IC 50. The switch S53 is set to an off state based on the control signal Sig52 inputted from the control IC 50.

The high-frequency reception signal received by the antenna ANT5 is inputted to the band-pass filter F51. The band-pass filter F51 allows the high-frequency reception signal to pass through its passband. The high-frequency reception signal that has passed through the band-pass filter F51 is inputted to the attenuator A5 via the switch 54.

The attenuator A5 attenuates the high-frequency reception signal that has passed through the switch S54 to an appropriate level. The high-frequency reception signal that has been attenuated by the attenuator A5 passes through the switch S52 and is outputted from the terminal R5 as the high-frequency reception signal RXout5.

(R-6-1) The case of reception (normal) by the antenna ANT6 will be described. A sixteenth row 616 in Table 600 indicates portions of the high-frequency signal transmission/reception circuit 1c through which a high-frequency reception signal passes in the case of reception (normal) by the antenna ANT6.

In the case of reception (normal) by the antenna ANT6, the switch S61 is set to an on state based on the control signal Sig61 inputted from the control IC 60. Additionally, the switch S63 is set to an on state based on the control signal Sig62 inputted from the control IC 60. The switch S62 is set to an off state based on the control signal Sig61 inputted from the control IC 60. The switch S64 is set to an off state based on the control signal Sig62 inputted from the control IC 60.

The high-frequency reception signal received by the antenna ANT6 is inputted to the band-pass filter F61. The band-pass filter F61 allows the high-frequency reception signal to pass through its passband. The high-frequency reception signal that has passed through the band-pass filter F61 is inputted to the low-noise amplifier LA6 via the switch 63.

The low-noise amplifier LA6 amplifies the high-frequency reception signal that has passed through the switch S53. The high-frequency reception signal that has been amplified by the low-noise amplifier LA6 passes through the switch S61 and is outputted from the terminal R6 as a high-frequency reception signal RXout6.

(R-6-2) The case of reception (during high input) by the antenna ANT6 will be described. A seventeenth row 617 in Table 600 indicates portions of the high-frequency signal transmission/reception circuit 1c through which a high-frequency reception signal passes in the case of reception (during high input) by the antenna ANT6.

In the case of reception (during high input) by the antenna ANT6, the switch S62 is set to an on state based on the control signal Sig61 inputted from the control IC 60. Additionally, the switch S64 is set to an on state based on the control signal Sig62 inputted from the control IC 60. The switch S61 is set to an off state based on the control signal Sig61 inputted from the control IC 60. The switch S63 is set to an off state based on the control signal Sig62 inputted from the control IC 60.

The high-frequency reception signal received by the antenna ANT6 is inputted to the band-pass filter F61. The band-pass filter F61 allows the high-frequency reception signal to pass through its passband. The high-frequency reception signal that has passed through the band-pass filter F61 is inputted to the attenuator A6 via the switch 64.

The attenuator A6 attenuates the high-frequency reception signal that has passed through the switch S64 to an appropriate level. The high-frequency reception signal that has been attenuated by the attenuator A6 passes through the switch S62 and is outputted from the terminal R6 as the high-frequency reception signal RXout6.

According to the high-frequency signal transmission/reception circuit 1c of the third embodiment, it is possible to suppress an increase in circuit scale by adopting a changeover switch and a selection switch for inputting an SRS signal between the reception antenna and the amplifying unit. In addition, by inputting an SRS signal at a position that does not pass through the path that bypasses the low-noise amplifier, it is not necessary to configure the path that bypasses the low-noise amplifier so as to support high power.

According to the high-frequency signal transmission/reception circuit 1c of the third embodiment, it is possible to increase the number of antennas as compared to the high-frequency signal transmission/reception circuit 1a of the first embodiment and the high-frequency signal transmission/reception circuit 1b of the second embodiment. In particular, in a dual-screen mobile communication device, since the housing tends to have a larger volume, it is possible to increase the number of antennas provided in the housing. In addition, as the volume of the housing increases, it is possible to provide antennas at positions spaced apart from each other within the housing.

### Fourth Embodiment

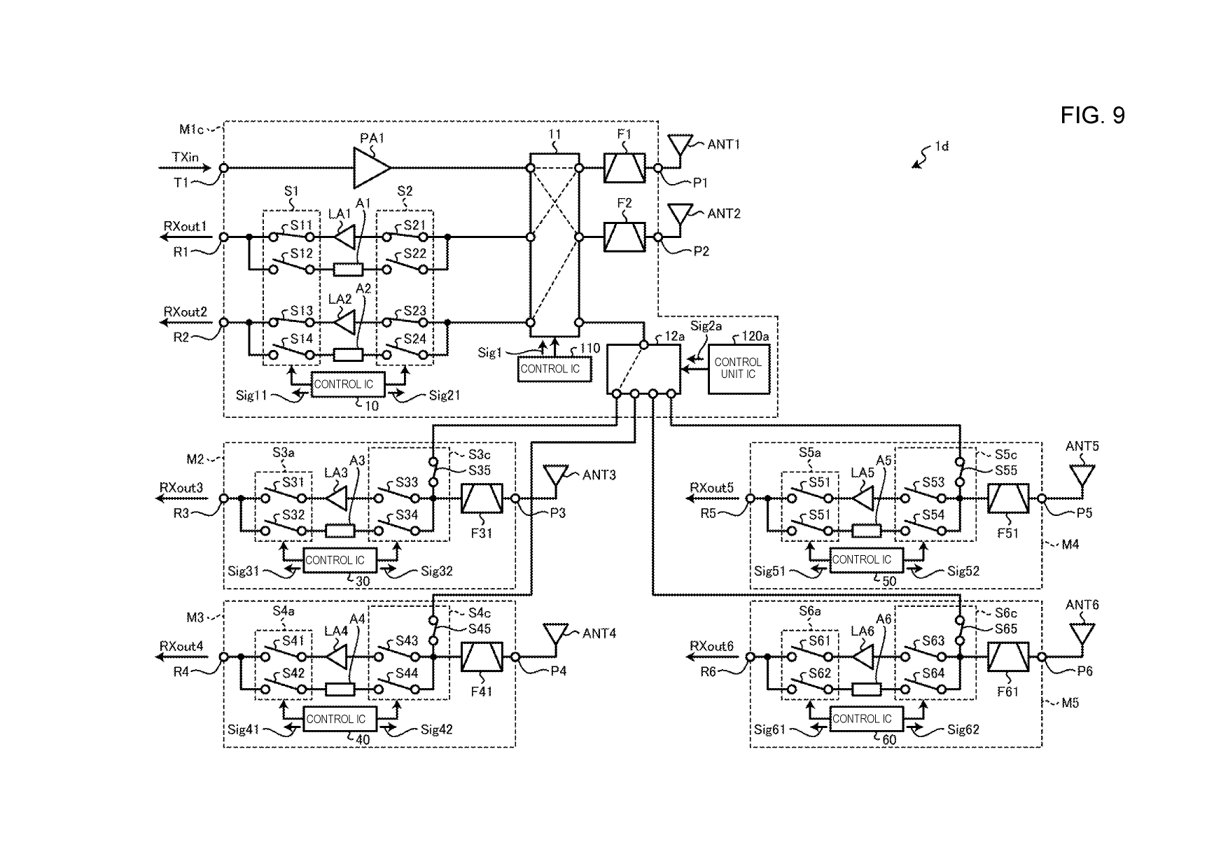

FIG. 9 is a diagram illustrating the configuration of a high-frequency signal transmission/reception circuit 1d of a fourth embodiment. The high-frequency signal transmission/reception circuit 1d illustrated in FIG. 9, like the high-frequency signal transmission/reception circuit 1b described with reference to FIG. 6, differs from the high-frequency signal transmission/reception circuit 1c in the positions of the band-pass filters. That is, the high-frequency signal transmission/reception circuit 1d has a configuration in which a module M1c is used instead of the module M1b. In the module M1c, the band-pass filter F1 is provided between the TRX switch 11 and the antenna ANT1, and the band-pass filter F2 is provided between the TRX switch 11 and the antenna ANT2.

In the high-frequency signal transmission/reception circuit 1c, the band-pass filter F1 is provided between the TRX switch 11 and the antenna ANT1. In contrast, in the high-frequency signal transmission/reception circuit 1d, no band-pass filter is provided between the power amplifier PA1 and the TRX switch 11. Additionally, in the high-frequency signal transmission/reception circuit 1c, the band-pass filters F11 and F21 are provided between the TRX switch 11 and the switch group S2. In contrast, in the high-frequency signal transmission/reception circuit 1d, no band-pass filter is provided between the TRX switch 11 and the switch group S2. Therefore, in the case of transmitting the SRS signal by the antennas ANT3 and ANT4, the number of band-pass filters through which the signal passes is smaller than in the case of the high-frequency signal transmission/reception circuit 1c. For this reason, it is possible to reduce the degradation of the SRS signal.

Note that, in the case of transmission (normal) by the antenna ANT1, the transmission signal that has passed through the TRX switch 11 passes through the band-pass filter F1; thus, the transmission signal outputted from the antenna ANT1 is equivalent to the case of FIG. 7. Additionally, in the case of transmission (normal) by the antenna ANT2, the transmission signal that has passed through the TRX switch 11 passes through the band-pass filter F2; thus, the transmission signal outputted from the antenna ANT2 is equivalent to the case of FIG. 7.

According to the high-frequency signal transmission/reception circuit 1d of the fourth embodiment, it is possible to suppress an increase in circuit scale by adopting a changeover switch and a selection switch for inputting an SRS signal between the reception antenna and the amplifying unit. In addition, by inputting an SRS signal at a position that does not pass through the path that bypasses the low-noise amplifier, it is not necessary to configure the path that bypasses the low-noise amplifier so as to support high power.

Furthermore, in the high-frequency signal transmission/reception circuit 1d of the fourth embodiment, it is possible to reduce the number of band-pass filters as compared to the first embodiment, thereby suppressing an increase in circuit scale. It is also possible to reduce the number of band-pass filters through which the signal passes, thereby reducing the degradation of the SRS signal.

According to the high-frequency signal transmission/reception circuit 1d of the fourth embodiment, it is possible to increase the number of antennas as compared to the high-frequency signal transmission/reception circuit 1a of the first embodiment and the high-frequency signal transmission/reception circuit 1b of the second embodiment. In particular, in a dual-screen mobile communication device, since the housing tends to have a larger volume, it is possible to increase the number of antennas provided in the housing. In addition, as the volume of the housing increases, it is possible to provide antennas at positions spaced apart from each other within the housing.

What is claimed is:

1. A high-frequency signal transmission/reception circuit that transmits a sound reference signaling (SRS) signal, comprising:
a transmission/reception antenna terminal;
a transmission/reception (TRX) switch configured to switch between a path from an amplifier to the transmission/reception antenna terminal and a path to a changeover switch, the amplifier being configured to amplify a transmission signal;
a reception antenna; and
a reception circuit,
wherein the reception circuit comprises a reception antenna terminal, an amplifier unit that is configured to amplify a reception signal, and a bypass switch;
the changeover switch is connected between the TRX switch and the reception circuit; and
by the changeover switch, the SRS signal inputted via the bypass switch is transmitted via the reception antenna terminal.

2. The high-frequency signal transmission/reception circuit according to claim 1,
wherein the reception circuit comprises a plurality of reception circuits,
wherein the changeover switch is configured to select a connection with the plurality of reception circuits, and
wherein the SRS signal is input between one of the plurality of reception antenna terminals and the amplifier unit corresponding to that reception antenna terminal.

3. The high-frequency signal transmission/reception circuit according to claim 1, wherein in the reception circuit, a filter is between the amplifier unit and the reception antenna terminal.

4. The high-frequency signal transmission/reception circuit according to claim 1, wherein the SRS signal is amplified by the amplifier, and is transmitted via the TRX switch, the changeover switch, and the bypass switch, without passing through the amplifier unit, and via the reception antenna terminal.

5. The high-frequency signal transmission/reception circuit according to claim 1, wherein at least two of the TRX switch, the changeover switch, the bypass switch, and the amplifier unit are on a same substrate.

6. The high-frequency signal transmission/reception circuit according to claim 1, further comprising:
a filter between the TRX switch and the transmission/reception antenna terminal,
wherein the filter has a passband comprising a frequency of the transmission signal.

7. The high-frequency signal transmission/reception circuit according to claim 1,
wherein the reception circuit comprises:
the amplifier unit;
the bypass switch;
a filter;
an input-side switch on an input side of the amplifier unit; and
an output-side switch on an output side of the amplifier unit,
wherein the SRS signal is inputted to a first end of the bypass switch,
wherein a first end of the filter is connected to the reception antenna terminal, and
wherein a second end of the bypass switch, a second end of the filter, and a second end of the input-side switch are connected.
